(19) United States
(12) Patent Application Publication
(10) Pub. No.: US 2026/0000102 A1
(43) Pub. Date: Jan. 1, 2026

(54) DEHYDRATED MUSHROOM INGREDIENTS, TEXTURISED MUSHROOM PRODUCTS, AND METHODS OF PRODUCING THE SAME

(71) Applicant: FABLE HOLDINGS PTY LTD, Hunchy, Queensland (AU)

(72) Inventor: James FULLER, Hunchy, Queensland (AU)

(73) Assignee: FABLE HOLDINGS PTY LTD, Hunchy, Queensland (AU)

(21) Appl. No.: 19/107,892

(22) PCT Filed: Aug. 28, 2023
(86) PCT No.: PCT/AU2023/050831

§ 371 Date: Feb. 28, 2025

(30) Foreign Application Priority Data
Aug. 28, 2022 (AU) 2022902467

(51) Int. Cl. A23L 31/00; A23J 3/22; A23L 5/00; A23L 5/10; A23L 5/20

(52) U.S. Cl. CPC A23L 31/00; A23J 3/227; A23L 5/11; A23L 5/17; A23L 5/20; A23L 5/55

(57) ABSTRACT

The present invention relates to a dehydrated mushroom ingredient with a modified rehydration capacity, where the dehydrated mushroom ingredient can be rehydrated to produce texturised mushroom products, and methods of producing and using said ingredient. Specifically, the texturised mushroom product of the invention have a similar texture to real meat.

### RELATED APPLICATIONS

This application claims priority to Australian Application No.: 2022902467, file Aug. 28, 2022, the contents of which is hereby incorporated by reference in its entirety.

### FIELD OF THE INVENTION

The present invention relates to a dehydrated mushroom ingredient with a modified rehydration capacity, where the dehydrated mushroom ingredient can be rehydrated to produce texturised mushroom products, and methods of producing and using said ingredient.

### BACKGROUND OF THE INVENTION

In response to concerns about the warming effect of greenhouse emissions produced by the livestock industry, as well as awareness of the effects of land clearing measures, water usage, and animal rights, consumers are increasingly seeking ways to reduce, eliminate or substitute animal products from their diets. This has spawned a large industry devoted to plant-based foods designed to provide the same flavour and nutritional benefits as animal-based protein, with the products showing substantial variability in their quality, availability, convenience, and applicability to conventional cooking methods.

In particular, as many consumers are looking for plant-based foods that can be used as substitutes for meat in a range of food products, the challenge to replicate the flavour, texture and mouthfeel of meat products is ongoing and is often achieved by sacrificing nutritional value. Specifically, many pant-based foods achieve their “meat-like” characteristics with the assistance of modified and synthetic starches, as well as undesirable amounts of preservatives, synthetic flavours and salts, and excessive processing.

Many plant-based food products also lack the versatility of real meat and cannot be used for dishes that require, for example, stewed, seared or braised meat, because they have a tendency to absorb excess amounts of liquid and disintegrate and/or lose texture when subjected to prolonged cooking processes popular for meat dishes. Indeed, in an attempt to mimic the desirable properties of meat, meat substitutes have been developed that incorporate cultured mammalian cells to more closely mimic the flavour, texture and smell of the food products. While these products may be promoted as more sustainable than meat, the addition of cultured cells would generally be undesirable for the majority of persons seeking a meat-free diet, and may also be offensive to consumers in view of the artificial, bioengineering aspect for the mammalian cell lines being used.

It is an object of the present invention to overcome or ameliorate one or more of the above discussed disadvantages of the prior art, or at least offer a useful alternative, such as, for example, a convenient, storage-stable, plant-based food product with a texture that resembles meat and which is suitable to for a range of cooking techniques.

Specifically, it would be desirable to develop a meat substitute that more closely resembles different types, cuts and preparations of meat that have at least similar, textural, visual, aroma and/or flavour profiles of real meat.

Any discussion of the prior art throughout the specification should in no way be considered as an admission that such prior art is widely known or forms part of common general knowledge in the field.

### SUMMARY OF THE INVENTION

According to a first aspect the present invention provides a method of producing a dehydrated mushroom ingredient with a modified rehydration capacity, comprising the steps of:
providing a raw mushroom material with at least 50% (w/w) water content;
oil immersion frying said raw mushroom material to produce a dehydrated mushroom ingredient with a water content from about 1% (w/w) to about 30% (w/w); and
de-oiling the dehydrated mushroom ingredient to produce an ingredient with an oil content of at least 1% (w/w),
   wherein the oil immersion frying is performed in an oil at a temperature from about 80° C. to about 200° C., at a pressure from 1.5 kPa and 103 kPa, and for a duration of about 10 seconds to about 900 seconds.

In other embodiments, there is provided a method of producing a dehydrated mushroom ingredient with a modified rehydration capacity for use in the production of a rehydrated texturised mushroom product, comprising the steps of:
providing a raw mushroom material with at least 50% (w/w) water content;
oil immersion frying said raw mushroom material to produce a dehydrated mushroom ingredient with a water content from about 5% (w/w) to about 30% (w/w); and
de-oiling the dehydrated mushroom ingredient to produce an ingredient with an oil content of at least 1% (w/w),
   wherein the oil immersion frying is performed in an oil at a temperature from about 80° C. to about 200° C., at a pressure of from about 1.5 kPa to about 103 kPa, and for a duration of 10 seconds to 900 seconds.

In further embodiments, there is provided a method of producing a texturised mushroom product, comprising the steps of:
providing a raw mushroom material with at least 50% (w/w) water content;
oil immersion frying said raw mushroom material to produce a dehydrated mushroom ingredient with a water content from about 5% (w/w) to about 30% (w/w); and
de-oiling the dehydrated mushroom ingredient to produce an ingredient with an oil content of at least 1% (w/w) to produce a dehydrated mushroom ingredient with a modified rehydration capacity, wherein the oil immersion frying is performed in an oil at a temperature from about 80° C. to about 200° C., at a pressure of from about 1.5 kPa to about 103 kPa, and for a duration of about 10 seconds to about 900 seconds, and
rehydrating the dehydrated mushroom ingredient to produce a texturised mushroom product.

In yet another aspect of the invention, there is provided a method of producing a texturised mushroom product, comprising the steps of:
preparing a raw mushroom material with at least 50% (w/w/) water content;
oil immersion frying said raw mushroom material to produce a dehydrated mushroom ingredient with a water content from about 5% (w/w) to 30% (w/w);
de-oiling the dehydrated mushroom ingredient to produce an ingredient with oil content of at least 1% (w/w); and
rehydrating said dehydrated mushroom ingredient liquid until the mushroom material is substantially saturated to produce a texturised mushroom product,
wherein the oil immersion frying is performed in an oil at a temperature from about 80° C. to about 200° C., at a pressure from about 1.5 kPa to about 103 kPa, and for a duration of about 10 seconds to about 900 seconds.

In yet another aspect, the invention provides for uses of the dehydrated mushroom ingredient or texturised mushroom product in the manufacture of a food product. The food product may be vegetarian, vegan, or a blended product (e.g. incorporating animal-derived meat). Further, the food product may be for human consumption, or for consumption by a non-human animal (e.g. a pet food).

Other and further aspects and features of the disclosure will be evident from reading the following detailed description of the embodiments, which are intended to illustrate, not limit, the present disclosure.

### DETAILED DESCRIPTION

### Definitions

By “meat substitute” is meant a substance that can act as a substitute for any type of meat, where the meat is the flesh or organ of any animal such as, but not limited to, beef, lamb, mutton, poultry, game animals, kangaroo, and the like. The meat substitute may be a substitute for any cut of meat, and may be a substitute for meat in any prepared form, such as, but not limited to, minced meat, shredded meat, cubed, diced and/or sliced meat, and meat strips. The meat substitute is vegetarian (free of animal flesh products, including animal or animal derived cells). Preferably, the meat substitute is vegan (substantially free of any animal derived products). The meat substitute may be in a form suitable for immediate consumption or may require cooking, heating or further processing as desired. Further, meat substitute may be for human or non-human animal consumption.

By “mushroom-based” is meant that the main proteinaceous and/or fibrous ingredient in the meat substitute is mushroom or mushroom derived. It would be understood that a mushroom-based meat substitute produced using a dehydrated mushroom ingredient and/or a texturised mushroom product of the invention may comprise additional proteinaceous and/or fibrous plant-based material and/or additional synthetic proteinaceous and/or fibrous material, but that at least 50% (w/w) of the proteinaceous and/or fibrous content of the mushroom-based meat substitute would be mushroom or mushroom derived material. The mushroom-based meat substitute may comprise other vegetable matter, but would exclude any meat derived from an animal.

The mushroom(s) used to prepare the raw mushroom material of the methods of the present invention can be any edible mushroom. By “edible” is meant either part or all of the mushroom may be safely consumed by a human when fresh, or either part or all of the mushroom may only be safely consumed by a human after a processing or cooking step, wherein the processing or cooking may remove or inactive any harmful components of the mushroom or part thereof. By safely consumed is meant that the consumption does not result in ill-health or death of the consumer.

By “modified rehydration capacity” is meant that when a dehydrated mushroom ingredient of the present invention is subsequently rehydrated with any suitable liquid capable of restoring lost water, the mushroom product will bind modified amount of said liquid when compared to a corresponding mushroom material dehydrated by conventional means (such as air or oven dried), though the total absorption capacity may be equal to or higher than the corresponding raw mushroom material. This modified rehydration capacity occurs due to water being firmly bound to the internal structure of the mushroom which is changed as a consequence of applying dehydration method of the invention relative to a corresponding mushroom material dehydrated by conventional means. However, statically held water, which is held through forces like surface tension and capillary force, contributes to the total absorption capacity and total moisture content of the dehydrated mushroom ingredient. These forces can enable a dehydrated mushroom ingredient prepared according to the present invention and rehydrated to have a moisture up to and even surpass the original moisture content of the raw mushroom material. In some instances, however, the rehydration capacity of the dehydrated mushroom ingredient of the invention may be substantially less than the water holding capacity of the original raw mushroom material.

In the context of the present invention, “water content” means the amount of water present in a food or substance. Water content is expressed as a percentage, representing the ratio of the mass of water in the food to the total mass of the food, multiplied by 100. Water content is an important parameter in the food industry as it can affect the taste, texture, shelf life, and overall quality of a product. Typically, water content is measured by the drying oven method (i.e. loss on drying). In this method, a small sample of the food is weighed and subsequently placed in a drying oven at a specific temperature for a specified period of time. The oven's heat gradually removes the water content from the sample, and the sample is reweighed at regular intervals until its weight stabilizes. The difference in weight before and after drying gives the water content. Other methods of determining water content include Karl Fischer Titration, Microwave Moisture Analysis, Infrared Moisture Balance, Freeze Drying (Lyophilization) and Near-Infrared Spectroscopy (NIR).

In the context of the present invention, “total absorption capacity” (or TAC) means the total amount of liquid (preferably a water-based liquid, or water per se) that can be held in a material at the point of substantial saturation. TAC (weight %) can be measured using the following formula:

$$TAC ( \% ) = ( ( Final weight - initial weight ) / Initial weight ) \times 100$$

The phrase ‘substantial saturation’ in this context means that a material has absorbed as much liquid as it can.

TAC is preferably measured at room temperature at atmospheric pressure. Alternatively, where the TAC for a dehydrated mushroom ingredient prepared according to the present invention is determined under different temperature and pressure conditions, the corresponding control is treated under identical conditions.

In the context of the present invention, “water binding capacity” (or WBC) means ability of a substance to bind or retain water within its structure. Different to “total absorption capacity”, WBC is the measure of water (i.e. a water-based liquid, or water per se) in the absence of an external water or moisture source (e.g. where the external water or moisture source is drained). WBC (weight %) can be measured using the following formula:

$$WBC ( \% ) = ( ( Initial weight - Final weight ) / Initial weight ) \times 100$$

For the purposes of this disclosure, by “raw mushroom material” is meant any mushroom material that is, or has been, fresh (i.e. harvested within 7 days of being used in the methods of the invention), frozen, cured, brined, dried and rehydrated, blanched and/or smoked at any stage prior to being used in the method of the present invention, provided the raw mushroom material subjected to oil immersion frying has a water content of at least 50% (w/w). Preferably, the raw mushroom material would not have been subjected to temperatures in excess of 60° C. prior to the oil immersion frying, though blanching or air drying and rehydrating temperatures can go up to 100° C. for short periods of time.

The term “plant-based oil” used herein may be regarded as being inclusive of any fat, or oil, that is extracted from a plant and that which may be suitable for use in oil immersion frying at the required temperature ranges. The plant-based oil may be any fat or oil selected from the group consisting of coconut oil, soybean oil, sunflower oil, olive oil, castor oil, palm oil, safflower, canola oil, flaxseed oil, grapeseed oil, rice bran oil, linseed oil, hemp oil, cottonseed oil, peanut oil, rapeseed oil, almond oil, and sesame oil, as well as other oils from nuts and seeds, and combinations or derivatives thereof. The oil may be solid at room temperature and may be selected from the group consisting of coconut oil, cocoa butter, palm oil, palm kernel oil, and vegetable shortening, and combinations or derivatives thereof.

Reference throughout this specification to “a embodiment,” “an embodiment,” or “one embodiment” means that a particular feature, structure, or characteristic described in connection with the embodiment is included in at least one embodiment of the disclosed subject matter. Thus, appearances of the phrases “in an embodiment” or “in one embodiment” in various places throughout this specification are not necessarily referring to the same embodiment.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the terms “substantially”, “at least” or “about” will be understood to not be limited to the value for the range qualified by the terms. For example, the term “about” may encompass a range of ±5%, or ±2.5%, or ±1%, or ±0.5% of the cited value. Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other structures, components, and materials as substitution or replacement to the structures, components, and materials disclosed herein. In other instances, one or more structures, components, and materials disclosed herein may altogether be omitted, and equivalent structures, components, and materials may be used in lieu thereof. Also, in the present disclosure, well-known structures, materials, or operations are not described in detail to avoid obscuring subject matter pertaining to aspects of the present invention.

Recitation of ranges of values herein is merely intended to serve as a shorthand method of referring individually to each separate value falling within the range. Unless otherwise indicated herein, each individual value is incorporated into the specification as if it were individually recited herein. For example, if a range is from about 1 to about 50, it is deemed to include, for example, 1, 7, 34, 46.1, 23.7, or any other value or range within the range.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

### Details of the Preferred Embodiments

The present disclosure relates to a dehydrated mushroom ingredient, and a corresponding rehydrated mushroom product, that have desirable characteristics as a nutritional and generally vegetarian food product that allows for flexibility in storage, processing, cooking and consumption. Despite mushroom often being touted as “meaty”, the resistance (or “bounciness”) of fresh mushroom material, or cooked from fresh mushroom material, is not a close approximation to the texture of cooked meat.

The texturised mushroom product produced from rehydration of the dehydrated mushroom ingredient of the present invention (which comprises a modified rehydration capacity compared to a corresponding raw mushroom material) is a food product that may be utilised as a meat substitute, a mushroom-based meat substitute, or further processed to produce a meat-substitute or mushroom-based meat substitute, due to the texturised mushroom product having properties that resemble meat products. To this point, the inventors have surprisingly found that the texturised mushroom product of the invention has a texture, chewiness and mouthfeel that is closely comparable to cooked animal meat. In embodiments, the texturised mushroom product of the invention is substantially devoid of mushroom flavour and/or smell of mushroom.

This texturised product can be retorted for additional shelf stability, frozen for shipping and storage for extended periods of time, cooked (i.e. fried, stewed, sautéed, roasted), thawed, and/or reheated and/or combinations thereof in much the same way a cooked meat product can without detriment to the texture, mouthfeel and chewiness of the mushroom product. In embodiments, the texturised mushroom product may be incorporated with other ingredients, or blended with meat derived from animals (e.g. beef, chicken, pork and the like, and combinations thereof) to provide a blended product.

Due to the modified rehydration capacity of the dehydrated mushroom ingredient, even when rehydrated by full submersion, and/or intense high heat and pressure processes (i.e. boiling or cooking), the resulting texturised mushroom product will maintain the bouncy textures of cooked meat with a similar resistance even as the particles diminish in size with progressive mastication. This feature of the texturised product also reduces (or substantially excludes) the need for additional starches, fibres, or binders when packaging/storing products made using the texturised mushroom product.

In embodiments, the level of allowed absorption can be generally controlled with the parameters heating raw mushroom material (e.g. the parameters of oil immersion frying), which is a major determining factor in the resulting water content of the dehydrated mushroom ingredient, as well as the ingredient's total absorption capacity (TAC) and water binding capacity (WBC).

Advantageously, the methods of the present invention produce desirable dehydrated mushroom ingredient, and rehydrated texturised mushroom products, even when parts of the mushroom that may be typically discarded, such as the stalk/stipe/stem or the vegetative mycelium, are used.

To explain further, the dehydrated mushroom ingredient produced according to the methods of the invention is made with an intention to subsequently rehydrate the ingredient to produce a texturised mushroom product. Advantageously, preparing the dehydrated mushroom ingredient according to the methods of the invention results in an ingredient that is storage stable (i.e. without the need for refrigeration, freezable, transportable, lightweight, ready to be subjected to further processing, and which has a modified rehydration capacity. By “modified rehydration capacity” is meant that when the dehydrated mushroom ingredient is subsequently rehydrated with any suitable liquid (i.e. preferably water per se, or water-based seasoned solution), the mushroom ingredient may only absorb a limited amount of said liquid, irrespective of how much liquid is used to rehydrate the mushroom ingredient and how long the mushroom ingredient is submerged in said liquid.

For example, a dehydrated mushroom ingredient produced according to the method of the invention may be rehydrated in a 5×, 10× or 20× excess of liquid (i.e. for 1 g of ingredient, a 5× excess would be 5 g of liquid, and so on) for 1 minute, 5 minutes or 10 minutes, and the amount of liquid absorbed by the dehydrated mushroom ingredient to produce a rehydrated mushroom product will be substantially similar, and the texture of the rehydrated mushroom product will be substantially similar, irrespective of the volume of liquid or time of rehydration.

One advantage of the present invention is that it goes against conventional wisdom associated with mushrooms in view of the widespread understanding that mushrooms need to be kept dry as they will absorb excess water like sponges in a manner that is generally uncontrollable.

The dehydrated mushroom ingredient of the present invention differs from commercially produced “mushroom chips”, commonly sold as a snack food throughout South East Asia, which are often prepared by air-drying, air-frying or oven baking at very high temperatures to essentially remove all moisture from the mushroom material, which also induces Maillard browning. Unlike the dehydrated mushroom ingredient produced according to the methods of the present invention, mushroom chips produced by conventional methods are not designed or intended to be rehydrated, and doing so is counterintuitive. Indeed, as with conventional potato-based chips, the mushroom chips must be stored without air or moisture, as they lose the desired crispiness quickly which would be viewed as negatively affecting the chip products. In cases where these mushroom chips are prepared by frying in oil, key criteria for a successful chip are low colour change, lowest possible water content, and crispiness to be maintained during long periods of ambient storage before retail sale. Rehydration is therefore not an option. Additionally, manufacturers of conventionally prepared mushroom chips intentionally adopt preparation processes which retain a mushroom flavour profile.

The dehydrated mushroom ingredient produced according to the methods of the invention is also freezable for storage and/or transport, which is advantageous over fresh mushroom material, which does not freeze well due to the high water content (up to 95% for commonly commercially produced mushrooms). Generally, when edible mushroom material is frozen from a fresh state, the internal moisture forms less dense crystal ice structures, expands and ruptures the cell walls, the subsequently thawed mushroom material changes in both colour and texture, resulting in an undesirable darker and softer mushroom. Further to this, subsequent conventional cooking of frozen and then thawed fresh mushroom material can lead to mushrooms with an extremely “mushy” texture and a propensity to absorb excess water into the ruptured, but still intact, cellular matrix causing a slimy, or mushy mouth feel.

Indeed, when contemplating long term storage of mushroom products such they can be used for subsequent cooking purposes, the pre-storage treatment options are typically limited to canning, pickling, air-drying, freezing after blanching, steaming or sauteing, and/or freeze-drying, while oil-immersion frying of mushroom material with the intention of rehydrating said material for use in cooking has yet to be attempted in the field.

Fresh mushrooms may comprise up to 95% (w/w) water, but this may vary depending on the type of mushroom, the part of the mushroom, the age of the mushroom and how the mushroom has been stored etc. Accordingly, in embodiments, the raw mushroom material used in the methods of the invention comprises at least 50% (w/w) water content, generally indicating that the raw mushroom material is not dried mushroom material at the time it is being used as the raw mushroom material in the methods of the invention. Alternatively, the raw mushroom material may comprise conventionally dehydrated mushrooms being rehydrated to have at least 50% (w/w) water content.

In further embodiments of the invention, the raw mushroom material used in the methods of the invention comprises at least 55% (w/w) water content, or at least 60% (w/w) water content, or at least 65% (w/w) water content, or at least 70% (w/w) water content, or at least 75% (w/w) water content, or at least 80% (w/w) water content, or at least 85% (w/w) water content, or at least 90% (w/w) water content, or about 50-55% (w/w) water content, or about 50-60% (w/w) water content, or about 55-65% (w/w) water content, or about 70-75% (w/w) water content, or about 75-80% (w/w) water content, or about 60-70% (w/w) water content, or about 70-80% (w/w) water content, or about 80-90% (w/w) water content, or about 85-95% (w/w) water content.

In alternative embodiments, the mushroom material may comprise a mixture of fresh mushroom material and cured (e.g. salt cured) mushroom material. In further alternative embodiments, the mushroom material may comprise a mixture of dried and rehydrated mushroom material (i.e. conventionally dehydrated mushroom that has been rehydrated), blanched and dewatered mushroom material and/or fresh mushroom material. In other examples, the mushroom material may substantially comprise fresh mushroom, with a small amount of dried and rehydrated mushroom, or the mushroom material may substantially comprise dried and rehydrated mushroom.

In preferred embodiments of the invention, the raw mushroom material comprises a mixture of fresh mushroom material and mushroom material that has been dried, rehydrated and dewatered. In other embodiments of the invention, the raw mushroom material comprises a mixture of fresh mushroom material and mushroom material that has been dried and rehydrated and mushroom material that has been frozen, thawed and dewatered.

It would be understood that in instances where the raw mushroom material is a mixture of different types of mushroom material, the water content of at least 50% (w/w) would be an average water content of the raw mushroom material.

Where it is necessary to rehydrate a previously dried or dehydrated mushroom material to produce a raw mushroom material, the rehydration step preferably comprises rehydration in water per se in the absence of other ingredients (such as sugar, salt or other additives). Rehydration in this context is preferably achieved by boiling dried or dehydrated mushroom material in water.

Without wishing to be bound by theory, the water content of the starting raw mushroom material (e.g. the water content pre-cooking) is an important aspect of the invention as it is the rapid evolution of the internal moisture of the raw mushroom material during cooking that leads to consolidation of structural fibres and dissolved solids around generated channels by which the moisture escapes. This forms irreversible rigid structures of altered proteins and fibres, with a structure resemblant of fresh mushroom material, but with more rigidity and defined porosity. As a consequence, the rigidity combined with the porosity means the dehydrated mushroom material has a “modified rehydration capacity”. By modifying the rehydration capacity as such, the water binding capacity (WBC) is lowered significantly, while the total absorption capacity (TAC) is altered. A higher overall TAC can be achieved if the surface porosity is maximized by the violent evolution of steam through the first moments of the process. This porosity character is maximized by selecting very high cooking temperatures of at least about 160° C., which should be maintained through the process. Preferably, when oil immersion frying, high cooking temperature may be maintained by having a product to oil ratio no higher than about 1:7 so the temperature does not reduce below about 145° C. in the process, and/or using low pressure environments.

In embodiments, a WBC ranging from about 55% (w/w) to about 65% (w/w) produces more preferred meat like textures. The natural water binding capacity of a conventionally cooked mushroom (e.g. air dried or oven baked) is generally greater than 70% (w/w).

In embodiments, heat (with or without vacuum) is applied to a raw mushroom material having a starting water content of at least 50% (w/w) for an intensity and time such that a dehydrated mushroom ingredient is produced. Preferably, the dehydrated mushroom ingredient produced by this method has a water content from about 1% (w/w) to about 30% (w/w). Following rehydration to produce a texturised mushroom product, the total absorption capacity (TAC) and/or the water binding capacity (WBC) of the texturised product is less than 75%, preferably less than 50%. In alternative embodiments, depending on the parameters of the heating process applied, the TAC of the texturised mushroom product may be greater than 50%, or greater than 75%. However, in such embodiments the WBC may be less than 75%, preferably less than 50%, further preferably less than 40%.

The raw mushroom material may be material from any fungus, including but not limited to mushrooms of the genera Agaricus, Lentinula, Pleurotus, Hericium, Laetiporus, Armillaria, Pioppini, Flammulina, Hypsizygus, Lyophyllum, Cantharellus, Craterellus, Clitocybe, Boletus, Grifola, Gyromitra, Hydnum, Cortinarius, Lactarius, Tricholoma, Volvariella, Ganoderma, Auricularia, Sparassis, Morchella, Tuber, Amanita, Clavariaceae, Calvatia, Coprinus, Fistulina, Leccinum, Lepiota, Suillus, Coprinopsis, Russula, Polyporus, or Fusarium, or combinations thereof.

More specifically, the raw mushroom material may be material from a fungus of the species Agaricus bernardii, Agaricus crocodilinus, Agaricus fuscofibrillosus, Agaricus haemorrhoidarius, Agaricus rodmanii, Agaricus bitorquis, Agaricus bisporus, Boletus aereus, Boletus appendiculatus, Boletus badius, Boletus barrowsii, Boletus bicolor, Boletus mirabilis, Boletus pinicola, Boletus regius, Boletus zelleri, Cantharellus lateritius, Clitocybe fragrans, Clitocybe odora, Clitopilus prunulus, Cortinarius armillatus, Entoloma abortivum, Falmmulina velutipes, Fusarium venenatum, Gomphus clavatus, Grifola frondosa, Polypilus frondosa, Gyromitra gigas, Hericium americanum, Hericium ramosum, Hericium erinaceus, Hericium corraloides, Hyspsizygus tessulatus, Lyophyllum decastes, Lyophyllum shimeji, Hygrophorus russula, Leccinum aurantiacum, Leccinum insigne, Leccinum scabrum, Lentinula edodes, Lentinula lateritia, Marasmius scorodonius, Pholiota aurivella, Phlogiotis helvelloides, Pluteus cervinus, Pleurotus ostreatus, Pleurotus eryngii, Polyozellus multiplex, Polyporus umbellatus, Ramaria botrytis, Rozites caperata, Russula aeruginea, Russula cyanoxantha, Russula delica, Russula nigricans, Russula vesca, Russula xerampelina, Sparassis crispa, Russula radicata, Strobilomyces floccopus, Strobilomyces confuses, Stropharia rugosoannulata, Suillis brevipes or Suillis pictus, or combinations thereof.

In some preferred embodiments of the invention, the raw mushroom material may be material from fungi of the genera Agaricus, Lentinula, Pleurotus, Hericium, Laetiporus, Armillaria, Pioppini, Flammulina, Hypsizygus, Lyophyllum, or Canterellus, or combinations thereof. In other embodiments of the invention, the mushroom material comprises two or more, or three or more, or four or more, or five or more different types of mushroom, wherein the type refers to a genera, species or sub-species. It would be understood that some mushrooms would have preferred flavour profiles and/or textures that would be more suited to some dehydrated mushroom ingredients and/or texturised mushroom products, albeit that it is preferred that dehydrated mushroom ingredients and/or texturised mushroom products prepared according to methods of invention are devoid of mushroom flavour and/or smell.

The raw mushroom material may contain any or all parts of the mushroom, including but not limited to the cap/pileus, the stalk/stipe/stem, the cup, the ring, the vegetative mycelium, or the gills, or combinations thereof. In embodiments of the invention, the raw mushroom material may substantially comprise only one part of the mushroom, or substantially comprise only two parts of the mushroom, or substantially comprise only three parts of the mushroom, or substantially comprise most of the parts of the mushroom that are ordinarily above ground during cultivation of the mushroom. For example, the raw mushroom material may substantially comprise mushroom stem only, or may substantially comprise mushroom stem and mushroom cap, or the mushroom material may substantially comprise mushroom cap only. In another example, the mushroom material may substantially comprise the entire above-ground portion of the mushroom. Alternatively, the raw mushroom material may substantially comprise the majority of the above-ground portion of the mushroom, but with parts of the stem trimmed away, or parts of the gills trimmed away or parts of the caps (such as the scales) trimmed away, or the mushroom material may substantially comprise mushroom stem and only portions of the cap.

In embodiments of the invention, the raw mushroom material may comprise mushroom material produced as a waste product during conventional, industrial mushroom harvesting, which may predominantly be stalk/stipe/stem and/or vegetative mycelium.

The raw mushroom material may comprise more than one type of mushroom and may comprise the same, or different, parts of more than one mushroom. In some examples, the mushroom material may substantially comprise the stems of one type of mushroom or the mushroom material may substantially comprise the stems of four or more types of mushroom, or the mushroom material may comprise the stem and the caps of two different types of mushrooms. In further examples, the raw mushroom material may substantially comprise the entire above-ground portion of two or more mushrooms, or the mushroom material may substantially comprise the caps of several different types of mushrooms.

Preferably, the raw mushroom material used in the methods of the present invention is substantially free of whole mushroom, in that the mushroom material would comprise mushroom that has undergone either mechanical or manual processing, or combinations thereof. The manual or mechanical processing is employed to produce a mushroom material comprising sliced, trimmed, ground, minced, grated, shredded, cut and/or chopped mushroom pieces. It would be understood the raw mushroom material could comprise mushroom pieces of different sizes and shapes, and the choice of size and shape of the mushroom pieces in the mushroom material would be dependent on factors such as the type of mushroom-based meat substitute being produce using the texturised mushroom products of the invention, the type of mushroom(s) and parts of mushrooms being used in the mushroom material, and the like. In alternative embodiments, the use of whole mushrooms is possible, and as such a combination of mushroom material from small particles, shreds, slices, strips, up to and including whole mushrooms may be used.

In some embodiments of the methods of the invention, the raw mushroom material substantially comprises dried mushroom stalk/stipe/stem and/or vegetative mycelium of the genera Agaricus, Lentinula, Pleurotus, Hericium, Laetiporus, Armillaria, Pioppini, Flammulina, Hypsizygus, Lyophyllum and/or Cantharellus, which are hydrated in water prior to being dewatered by centrifugation/pressing to give a raw mushroom material with at least 50% (w/w) water content, which is then shredded, sliced or minced in preparation for the oil immersion frying.

In other embodiments of the methods of the invention, the raw mushroom material substantially comprises fresh mushroom stalk/stipe/stem and/or vegetative mycelium of the genera Agaricus, Lentinula, Pleurotus, Hericium, Laetiporus, Armillaria, Pioppini, Flammulina, Hypsizygus, Lyophyllum and/or Cantharellus, which has at least 50% (w/w) water content, which is shredded, sliced or minced in preparation for the oil immersion frying.

In further embodiments of the methods of the invention, the raw mushroom material substantially comprises frozen mushroom stalk/stipe/stem and/or vegetative mycelium of the genera Agaricus, Lentinula, Pleurotus, Hericium, Laetiporus, Armillaria, Pioppini, Flammulina, Hypsizygus, Lyophyllum and/or Cantharellus, which are thawed and dewatered by centrifugation/pressing to give a raw mushroom material with at least 50% (w/w) water content, which is then shredded, sliced or minced in preparation for the oil immersion frying.

In embodiments, the raw mushroom material is not further processed or combined with other ingredients prior to oil immersion frying. That is, the raw mushroom material consists essentially of mushroom and excludes other ingredients (such as other protein ingredients, colours, taste or texture modifiers, farinaceous ingredients, flours or grains).

In embodiments, the methods of the invention comprise an oil immersion frying step, wherein oil immersion frying (also known as deep frying) of the raw-mushroom material requires that the raw mushroom material is completely submerged in the oil at the prescribed temperature and pressure for the majority of the prescribed time. That there is some variability in the time is merely meant to reflect the fact that, in a batch cooking process, pieces of the raw mushroom material may periodically be only partially submerged in the oil as the raw mushroom material circulates in the oil during the cooking process and that the oil/pressure may not be perfectly uniform for the whole cooking process. Nevertheless, the functional outcome of immersion frying is the rapid evolution of water of the internal moisture of the raw mushroom leading to consolidation of structural fibres and dissolved solids around generated channels by which the moisture escapes, and the formation of irreversible rigid structures of altered proteins and fibres, with a structure resemblant of fresh mushroom material, but with more rigidity and defined porosity.

The oil used for the oil immersion frying may be any oil or fat that can reach the appropriate temperatures. Preferably, the oil is a plant-based oil (i.e. vegetarian/vegan), but the oil could be lard, tallow, or clarified butter (ghee).

In some embodiments of the invention, the plant-based oil may be an oil with a high smoke point, such as, for example, diacylglycerol (DAG) oil, avocado oil, mustard oil, palm oil, peanut oil, rice bran oil, safflower oil, olive oil, or semi-refined sesame oil, or combinations or derivatives thereof.

The oil immersion frying is performed in an oil at a temperature from about 80° C. to about 200° C., at a pressure from about 1.5 kPa to about 103 kPa, and for a duration of about 10 seconds to about 900 seconds, to produce a dehydrated mushroom ingredient with a water content from about 1% (w/w) to about 30% (w/w). The skilled addressee would appreciate that the temperature, time and pressure used in an oil immersion frying process are generally linked. For example, with all other parameters being equal, when oil immersion frying is performed under vacuum pressure (often referred to as vacuum frying), the required oil temperatures would generally be lower than those required at atmospheric pressure (often referred to as ambient pressure) to achieve the same level of frying within a particular amount of time (i.e. where level of frying refers to the resulting water content of the dehydrated mushroom ingredient). Similarly, at a given pressure, increasing the oil temperature would decrease the time required to achieve the same level of frying at that particular pressure. At a given oil temperature and pressure, increasing the time of the oil immersion frying would generally result in a decrease in the water content of the produced dehydrated mushroom ingredient.

In embodiments of the methods of the invention, the oil immersion frying produces a dehydrated mushroom ingredient with a water content from about 1% (w/w) to about 30% (w/w), or a water content from about 10% (w/w) to about 20% (w/w), or a water content from about 5% (w/w) to about 15% (w/w), or a water content of from about 5% (w/w) to about 20% (w/w), or a water content from about 15% (w/w) to about 25% (w/w), or a water content from about 20% (w/w) to about 30% (w/w). Preferably, the oil immersion frying produces dehydrated mushroom ingredient with a water content from about 15% (w/w) to about 25% (w/w). Preferably, water content is determined by measuring the loss of water on drying (i.e. the drying oven method). In this method, the weight of the de-oiled dehydrated mushroom ingredient is initially measured, followed by determining the weight after airdrying (preferably for at least 24 hours at 75° C.). Water content is therefore represented as a percentage, representing the ratio of the mass of water in the food to the total mass of the food, multiplied by 100. In alternative embodiments, a commercial moisture content analyser or other method is employed to determine % water content (w/w).

The parameters of the oil immersion frying required to produce a dehydrated mushroom ingredient with a water content from about 1% (w/w) to about 30% (w/w) will depend on a number of factors such as the water content of the raw mushroom material, the type of mushroom and mushroom parts in the raw mushroom material, the size and shape of the pieces of the raw mushroom material, as well as the ways in which the raw mushroom material was prepared prior to the oil immersion frying. It would also be understood that, while the methods of the present invention are used to produce a dehydrated mushroom ingredient with a water content from about 1% (w/w) to about 30% (w/w), particular water content levels within this range may be preferred depending on the end use of the dehydrated ingredient and/or texturised product, and/or the desire level of rehydration of the subsequent texturised mushroom product.

The skilled addressee would not consider it an undue burden to perform some experimentation within the oil immersion frying parameters of the methods of the invention to produce a dehydrated mushroom ingredient with a water content from about 1% (w/w) to about 30% (w/w) with various desirable and/or preferred characteristics with respect to the dehydrated mushroom ingredient and/or the subsequent texturised mushroom product.

For example, a simple test may be performed using a preparation of raw mushroom material with at least 50% (w/w) water content, wherein the oil immersion frying is performed in at a temperature from about 80° C. to about 200° C., at a pressure of from about 1.5 kPa to about 103 kPa, and for a duration of about 10 seconds to about 900 seconds. In the event the dehydrated mushroom ingredient produced by oil immersion frying at a particular temperature, time and pressure has a water content that is too low, the parameters may be adjusted by, for example, decreasing the temperature of the oil and/or decreasing the time, and/or increasing the pressure from a vacuum pressure to a pressure closer to or equal to atmospheric pressure. An alternative solution may be to test the oil immersion frying at the same temperature, time and pressure with a raw mushroom material with a higher starting water content or using a higher mushroom to oil ratio.

In another example, in the event the dehydrated mushroom ingredient produced by oil immersion frying at a particular temperature, time and pressure has a water content is too high (e.g. above about 30% (w/w)), the parameters may be adjusted by, for example, increasing the temperature of the oil and/or increasing the time, and/or decreasing the pressure from an atmospheric pressure to a vacuum pressure. An alternative solution may be to test the oil immersion frying at the same temperature, time and pressure with a raw mushroom material with a lower starting water content or a higher oil to mushroom ratio.

In some embodiments of the methods of the invention, the oil immersion frying is performed in an oil at a temperature from about 90° C. to about 130° C., at a pressure from about 1.5 kPa to about 10 kPa (i.e. under vacuum), and for a duration of about 10 seconds to about 900 seconds.

In some embodiments of the methods of the invention, the oil immersion frying is performed in an oil at a temperature from about 160° C. to about 190° C., at a pressure of at least about 100 kPa, and for a duration of about 10 seconds to about 900 seconds.

In some embodiments of the methods of the invention, the oil immersion frying is performed in an oil at a temperature from about 105° C. to about 125° C., at a pressure from about 1.5 kPa to about 10 kPa (i.e. under vacuum), and for a duration of about 30 seconds to about 900 seconds.

In some embodiments of the methods of the invention, the oil immersion frying is performed in an oil at a temperature from about 160° C. to about 190° C., at a pressure of at least about 100 kPa, and for a duration of about 10 seconds to about 100 seconds.

In some embodiments of the methods of the invention, the oil immersion frying is performed in an oil at a temperature of about 130° C., under vacuum pressure, and for a duration of about 30 seconds.

In some embodiments of the methods of the invention, the oil immersion frying is performed in an oil at a temperature of about 110° C., under vacuum pressure, and for a duration of about 60 seconds.

In some embodiments of the methods of the invention, the oil immersion frying is performed in an oil at a temperature of about 130° C., under vacuum pressure, and for a duration of about 60 seconds.

In some embodiments of the methods of the invention, the oil immersion frying is performed in an oil at a temperature of about 95° C., under vacuum pressure, and for a duration of about 90 seconds.

In some embodiments of the methods of the invention, the oil immersion frying is performed in an oil at a temperature of about 110° C., under vacuum pressure, and for a duration of about 90 seconds.

In some embodiments of the methods of the invention, the oil immersion frying is performed in an oil at a temperature of about 95° C., under vacuum pressure, and for a duration of 120 seconds.

In some embodiments of the methods of the invention, the oil immersion frying is performed in an oil at a temperature of about 115° C., under vacuum pressure, and for a duration of about 300 seconds.

In some embodiments of the methods of the invention, the oil immersion frying is performed in an oil at a temperature of from about 140° C. to about 160° C., under vacuum pressure, and for a duration from about 80 seconds to about 45 seconds (i.e. as temperature increases, frying duration decreases).

In some embodiments of the methods of the invention, the oil immersion frying is performed in an oil at a temperature of about 180° C., under atmospheric pressure, and for a duration of about 30 seconds.

In some embodiments of the methods of the invention, the oil immersion frying is performed in an oil at a temperature of about 180° C., under atmospheric pressure, and for a duration of about 60 seconds.

In some embodiments of the methods of the invention, the oil immersion frying is performed in an oil at a temperature of about 170° C., under atmospheric pressure, and for a duration of about 30 seconds.

In some embodiments of the methods of the invention, the oil immersion frying is performed in an oil at a temperature of about 170° C., under atmospheric pressure, and for a duration of about 60 seconds.

In some embodiments of the methods of the invention, the oil immersion frying is performed in an oil at a temperature of about 170° C., under atmospheric pressure, and for a duration of about 90 seconds.

In some embodiments of the methods of the invention, the oil immersion frying is performed in an oil at a temperature of about 160° C., under atmospheric pressure, and for a duration of about 60 seconds.

In some embodiments of the methods of the invention, the oil immersion frying is performed in an oil at a temperature of about 160° C., under atmospheric pressure, and for a duration of about 90 seconds.

In some embodiments of the methods of the invention, the oil immersion frying is performed in an oil at a temperature of about 160° C., under atmospheric pressure, and for a duration of about 120 seconds.

In some embodiments of the methods of the invention, the oil immersion frying is performed in an oil at a temperature of about 180° C., under atmospheric pressure, and for a duration of about 60 seconds.

In some embodiments of the methods of the invention, the oil immersion frying is performed in an oil at a temperature from about 170° C. to about 180° C., at a pressure above atmospheric pressure, and for a duration of about 60 seconds to about 120 seconds.

In some embodiments, the oil immersion frying is performed in stages, where the frying is performed at more than one set of parameters that fall within the broader defined ranges for temperature, pressure and time.

In alternative embodiments, creation of the dehydrated mushroom ingredient of the invention is achieved by any method capable of achieving a rapid evolution of water from mushroom material having a starting water content of at least 50% (w/w). The sudden catastrophic evolution of moisture, in a controlled process yields a crisp, dry particle with significant changes to the flavour chemistry, physical volume, density and overall morphology. These novel textures and flavours, while unique for fungi, can closely replicate cooked animal protein textures and flavours upon subsequent rehydration with water.

In embodiments, rapid heating may be achieved by microwave energy. While microwave heating is a prevalent technique for food preparation due to its rapid energy transfer mechanism, the inventors have surprisingly found that microwave-induced behaviour of fresh mushroom particles within a vacuum environment can expedite moisture-mediated transitions, impacting the particle microstructure and form, thereby producing a dehydrated mushroom ingredient that is rehydratable to give a meat-like texturised product.

The reduced pressure in the vacuum is particularly advantageous in modulating the moisture's boiling point, leading to a departure from standard vaporisation dynamics, with distinct quantum features. This manifests as non-continuous energy leaps, resulting in localised stress within the particles. The heightened thermal stress ultimately triggers structural discontinuity, leading to abrupt burst phenomena with novel cavitation dynamics unique to the individual mushroom type and part (cap, sclerotia, mycelium, or stem). This uniqueness is directly related to the symmetry and organization of hyphal cells in the specific structures, along with cell size and thickness of chitin cell walls.

The burst particles, in turn, exhibit post-rupture morphological diversification, featuring distinctive geometries and volumes, with newly deposited soluble matter adhering to the inner surfaces of the newly generated structures. The vacuum environment, with its altered thermal dissipation mechanisms, leads to extended cooling times, prolonging the transition to thermal equilibrium.

In embodiments, microwave energy (with or without vacuum) is applied to a raw mushroom material having a starting water content of at least 50% (w/w) for an intensity and time such that a dehydrated mushroom ingredient is produced. Preferably, the dehydrated mushroom ingredient produced by this method has a water content from about 1% (w/w) to about 30% (w/w). Following rehydration to produce a texturised mushroom product, the total absorption capacity (TAC) and/or the water binding capacity (WBC) of the texturised product is less than 75%, preferably less than 50%.

Preferably, the microwave energy is applied under vacuum (i.e. microwave-vacuum dryer). In embodiments, the microwave power is from about 1 kW to about 5 kW, preferably from about 2 kW to 4 kW. In embodiments, the intensity of the microwave is set at about 20 W per g to about 100 W per g, preferably 40 W per g to about 70 W per g. In embodiments, pressure is from about 1 kPa to about 80 kPa, further preferably from about 20 kPa to about 50 kPa. In alternative embodiments, pressure is from about 1 kPa to about 20 kPa, preferably at least less than about 10 kPa. In embodiments, the length of time for microwave treatment is from about 60 s to about 200 s, preferably 100 s to 150 s.

The methods of the present invention include a step of de-oiling the dehydrated mushroom ingredient after the oil immersion frying, such that the dehydrated mushroom ingredient retains an oil content of at least 1% (w/w), and this may be achieved by any suitable means. Preferably, centrifugation at speeds from about 900 rpm to about 1200 rpm is employed to achieve de-oiling. While de-oiling is a conventional step is most food manufacturing processes that involve oil immersion frying, the intention of such a step is to remove as much oil as possible from the fried ingredient. However, in the disclosed methods, it has been surprisingly found that keeping a small amount of oil in the dehydrated mushroom ingredient is desirable for the mouthfeel and texture of the subsequently rehydrated, texturised mushroom product. In embodiments of the invention, the dehydrated mushroom ingredient is de-oiled after the oil immersion frying whilst retaining an oil content of at least 1% (w/w), at least 2% (w/w), at least 3% (w/w), at least 4% (w/w), or at least 5% (w/w). In alternative embodiments of the disclosed methods, the dehydrated mushroom ingredient is de-oiled after the oil immersion frying whilst retaining an oil content of about 1% (w/w) to about 5% (w/w). Preferably, the oil content after de-oiling is less than about 5%.

For microwave treatment, oil will optionally be added before and/or after making the dehydrated mushroom ingredient. As above, it has been surprisingly found that keeping a small amount of oil in the dehydrated mushroom ingredient is desirable for the mouthfeel and texture of the subsequently rehydrated, texturised mushroom product. In embodiments, the dehydrated mushroom ingredient prepared by microwaving contains an oil content of at least 1% (w/w), at least 2% (w/w), at least 3% (w/w), at least 4% (w/w), or at least 5% (w/w). In alternative embodiments, the dehydrated mushroom ingredient contains an oil content of about 1% (w/w) to about 5% (w/w). Preferably, the oil content after microwaving is less than about 5%.

In the methods of the disclosed invention, the texturised mushroom product is produced by rehydrating the modified dehydrated mushroom ingredient in any suitable liquid to produce a texturised mushroom product with a water content of at least 40% (w/w). The amount of liquid the dehydrated mushroom ingredient is capable of absorbing is generally limited, however, there may be instances when it is desirable for the texturised mushroom product to not be fully rehydrated. By this is meant that the dehydrated mushroom ingredient is rehydrated to a particular % water content to produce a texturised mushroom product that may have, for example, desirable texture, storability or cooking properties, but that the texturised mushroom product could absorb a limited amount of additional liquid if allowed.

Accordingly, in embodiments of the disclosed methods, the dehydrated mushroom ingredient is rehydrated in any suitable liquid to produce a texturised mushroom product with a water content of at least 40% (w/w), or at least 50% (w/w), or at least 60% (w/w), or at least 70% (w/w), or at least 80% (w/w), or at least 90% (w/w), or at least 95% (w/w). Preferably, the liquid for rehydration of the dehydrated mushroom ingredient is water or consisting essentially of water. Further preferably, the liquid for rehydration of the dehydrated mushroom ingredient is water excluding other ingredients or additives admixed into the water. Alternatively, the liquid for rehydration of the dehydrated mushroom ingredient is water comprising other ingredients or additives admixed into the water, such as flavours, seasonings, and/or preservatives.

In the methods of the invention, the texturised mushroom product may also be prepared by rehydrating the modified dehydrated mushroom ingredient in an excess of any suitable liquid until such time as the mushroom material and the liquid reach an absorption equilibrium to produce a texturised mushroom product. In these embodiments, the texturised mushroom product becomes substantially saturated with the liquid whilst retaining its structural and textural integrity. The amount of liquid that the dehydrated mushroom ingredient can absorb (i.e. the final % water content of the rehydrated, texturised mushroom product) is essentially programmable based on factors such as the attributes of the raw mushroom material (i.e. type of mushroom, starting water content), and the oil immersion frying conditions and resultant % water content of the dehydrated ingredient.

In embodiments of the invention, the dehydrated mushroom ingredient may be rehydrated to produce a texturised mushroom product with a water content below, or substantially equal to, or above the starting water content of the raw mushroom material. However, in all embodiments of the invention, the modified dehydrated mushroom ingredient of the invention will be rehydrated to a water content of at least 40% (w/w) to produce the texturized mushroom product. Preferably, the modified dehydrated mushroom material of the invention will be rehydrated to a water content of not more than 95% (w/w). Notably, the reabsorption of moisture is not equivalent to the way moisture was held in the original raw mushroom material. Thus, for example, for a dehydrated mushroom ingredient that may be rehydrated to produce a texturised mushroom product with a water content above the starting water content of the raw mushroom material, a higher proportion of the statically held moisture is predicted to be “free-water”, that is not held within the internal cells of the rehydrated product, but held within the newly created pores and cavities (i.e. extracellular space) of the texturised mushroom product. The inventors have surprisingly found that the newly created pores and cavities of the texturised mushroom product provides a consumer with a sensation and experience of a more densely connected fibre, with an abundance of readily available internal moisture comprised of mostly water but some fat, and that this is the closest approximation of the internal structure of traditional animal proteins that has yet been achieved by a non-animal derived material. Mastication of texturised mushroom product particles shears and breaks the particles into ever smaller versions of the original material, not yielding to a paste or changing textures like other extruded cereal proteins that are currently being used as the alternatives to a meat structure in plant based foods.

The dehydrated mushroom ingredient and/or the texturised mushroom product produced by the methods of the invention may be supplemented with additional components, such as, but not limited to, additional liquid, flavours, seasonings, preservatives, protein extracts, vegetables, or combinations thereof.

The preservative may be any substance that assists in the prevention of microbial growth and degradation of the composition. The preservative may be an anti-microbial or an anti-oxidant, and these may include components such as salt, herbaceous extracts, sugar, vinegar, parabens, or combinations thereof. In preferred embodiments of the invention, the compositions may comprise a preservative at a concentration of about 0.1% (w/w) to about 10% (w/w). More preferably, the compositions may comprise a preservative at a concentration of about 0.25% (w/w) to about 5% (w/w).

All publications and patents mentioned herein are hereby incorporated by reference in their entirety as if each individual publication or patent was specifically and individually indicated to be incorporated by reference. In case of conflict, the present application, including any definitions herein, will control.

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

Further examples of the invention are described below. However, it should be noted that the invention should not be limited to these examples, and that the invention is susceptible to variations, modifications and/or additions other than those specifically described, and it is to be understood that the invention includes all such variations, modifications and/or additions which fall within the scope of the claims.

### EXAMPLES

### Example 1: Production of a Modified Dehydrated Mushroom Ingredient

A fractional-factorial screen of temperature, pressure and time was performed to test the conductive thermal consolidation of a raw mushroom material (3-5 mm diced shitake stem) with a water content of at least 50% (w/w). The oil immersion frying was performed under atmospheric pressure, under vacuum (vacuum frying at about 10 kPa), and under pressure (pressure frying at about 103 kPa).

The resulting % water content (measured as g of water/100 g of dehydrated mushroom ingredient) of the dehydrated mushroom ingredient produced by each set of parameters is compiled below. Water content was determined by the drying method where samples of fried and de-oiled dehydrated mushroom ingredient was subject to oven drying at a temperature of 75° C. for at least 24 hrs, and the change in weight (i.e. water loss) recorded.

TABLE 1
Dehydrated mushroom ingredients produced at
different temperatures, pressures and time.

| | Moisture Content | | | |
|---|---|---|---|---|
| | XL | L | M | H |
| | <10 | 15 | 25 | 30+ |
| | Time (sec) | 110° C. | 120° C. | 130° C. |
| Deep fat fry vacuum | 30 | H | H | M |
| Deep fat fry vacuum | 60 | H | M | L |
| Deep fat fry vacuum | 90 | H | M | L |
| Deep fat fry vacuum | 120 | M | L | XL |

| | | 160° C. | 170° C. | 180° C. |
|---|---|---|---|---|
| Deep fat fry ambient | 30 | H | H | M |
| Deep fat fry ambient | 60 | H | M | L |
| Deep fat fry ambient | 90 | H | M | L |
| Deep fat fry ambient | 120 | M | L | XL |

| | | 160° C. | 170° C. | 180° C. |
|---|---|---|---|---|
| Deep fat fry pressure | 30 | H | H | H |
| Deep fat fry pressure | 60 | H | H | M |
| Deep fat fry pressure | 90 | H | H | M |
| Deep fat fry pressure | 120 | H | M | M |

XL = extra low;
L = low;
M = medium;
H = high

Generally, Table 1 shows that frying under vacuum achieves dehydration faster, when compared to ambient and pressure frying.

### Example 2: Comparison of Texturised Mushroom Product With Other Vegetables

Oil immersion frying was used to prepare dehydrated celery, potato, carrot and shitake mushroom products using 100 g raw/fresh starting material, all having a starting water of at least 70% (w/w).

The vegetables were cut to 3-5 mm in size and subject to frying in canola oil in a 10 L vacuum fryer, or a 4 L ambient pressure fryer, at temperatures ranging from about 106° C. to about 175° C., for about 1 to about 7 minutes, as required to produce dehydrated vegetable products with water contents of from about 10% (w/w) to about 30% (w/w), where water content was determined according to the method of Example 1.

Yield of the dehydrated vegetable products was determined relative to the 100 g initial weight before frying. The dehydrated vegetable products were all subjected to a submersion rehydration step in boiling water at ambient pressure and temperature for 1 to 5 minutes and the resulting rehydrated products assessed.

The results are shown in Table 2 below and demonstrate that only the rehydrated mushroom product retained texture and resistance when rehydrated.

TABLE 2
Dehydrated vegetable products produced at different temperatures,
pressures and time and subjected to subsequent rehydration.

| | Fry | | | Yield^{a} | Rehydration | | |
|---|---|---|---|---|---|---|---|
| Material | Method | ° C. | Min | (%) | time (Min) | Texture^{b} | Comments |
| Celery | Vacuum | 106 | 4 | 21.75 | 1 | 1 | Little resistance, |
| | | | | | | | soggy |
| Celery | Vacuum | 106 | 4 | 35.35 | 5 | 0 | No resistance, mushy |
| Celery | Ambient | 160 | 4 | 33.21 | 1 | 1 | Little resistance, |
| | | | | | | | soggy |
| Celery | Ambient | 160 | 4 | 47.42 | 5 | 0 | No resistance, mushy |
| Potato | Vacuum | 130 | 5 | 58.45 | 1 | 1 | Little resistance, |
| | | | | | | | soggy |
| Potato | Vacuum | 130 | 5 | 77.17 | 5 | 0 | No resistance, mushy |
| Potato | Ambient | 165 | 1.75 | 74.54 | 1 | 1 | Little resistance, |
| | | | | | | | soggy |
| Potato | Ambient | 165 | 1.75 | 86.99 | 5 | 0 | No resistance, mushy |
| Carrot | Vacuum | 130 | 7 | 35.71 | 1 | 1 | Little resistance, |
| | | | | | | | soggy |
| Carrot | Vacuum | 130 | 7 | 45.15 | 5 | 0 | No resistance, mushy |
| Carrot | Ambient | 170 | 2 | 53.70 | 1 | 1 | Little resistance, |
| | | | | | | | soggy |
| Carrot | Ambient | 170 | 2 | 66.66 | 5 | 0 | No resistance, mushy |
| Shiitake | Vacuum | 115 | 5 | 61.67 | 1 | 5 | Good resistance, |
| stem + cap | | | | | | | meaty |
| Shiitake | Vacuum | 115 | 5 | 65.00 | 5 | 5 | Good resistance, |
| stem + cap | | | | | | | meaty |
| Shiitake | Ambient | 175 | 1 | 91.96 | 1 | 5 | Good resistance, |
| stem | | | | | | | meaty |
| Shiitake | Ambient | 175 | 1 | 99.20 | 5 | 5 | Good resistance, |
| stem | | | | | | | meaty |

^{a}= (Yield of ingredient/fresh weight) × 100;
^{b}= a rating of ‘0’ means no texture and disintegrating, whereas a texture of 5 = meaty

The results of Table 2 demonstrate that the use of mushroom material is critical to methods of the invention and the same outcomes cannot be expected when using other vegetable material.

### Example 3: Comparison of TAC and WBC

An experiment was performed to compare the TAC and WBC of various mushroom materials. Diced raw mushroom material of 3-5 mm in size was treated as follows:
Air dry: 75° C. for 24 hrs.
Blanch: fresh mushroom boiled in water at ˜100° C. for 10 min
Oven cooked (all cooked until caramelised by not burnt)

| | |
|---|---|
| Shittake | 25 min at 180° C. |
| Enoki | 30 min at 180° C. |
| King Oyster | 28 min at 180° C. |
| Agaricus | 20 min at 180° C. |

Oil immersion (Fry) at ambient temperature for 1 min at 175° C.
Vacuum Frying (Vac Fry) at 1.9 kPa at 115° C. for 5 min

TAC was measured after blanching mushroom material for 5 mins at 100° C. WBC was determined after dewatering the mushroom material by centrifugation at 1200 rpm for 30-60 seconds. Results are shown in Table 3.

TABLE 3
Comparison of TAC and WBC for various
treated mushroom materials

| | Shiitake | Agaricus | King Oyster | Enoki |
|---|---|---|---|---|
| Air Dry TAC | 85.29% | 88.38% | 86.39% | 92.72% |
| Air Dry WBC | 79.92% | 85.58% | 82.23% | 89.95% |
| Blanch TAC | 90.98% | 93.09% | 91.87% | 92.68% |
| Blanch WBC | 88.39% | 91.22% | 87.58% | 89.24% |
| Oven Cooked TAC | 81.78% | 80.60% | 81.07% | 84.18% |
| Oven Cooked WBC | 75.56% | 80.13% | 79.88% | 79.58% |
| Fry MycoTex TAC | 50.63% | 49.38% | 65.58% | 71.46% |
| Fry MycoTex WBC | 56.18% | 48.32% | 58.32% | 67.86% |
| Vac Fry MycoTex TAC | 65.25% | 65.31% | 52.56% | 70.24% |
| Vac Fry MycoTex WBC | 50.63% | 49.38% | 65.58% | 71.46% |

The results show that TAC and WBC are reduced as a result of frying or microwaving by at least about 20% compared to the other treatments. Generally, TAC and WBC are advantageously reduced below 75% by frying compared to other treatments.

### Example 4: Taste Comparisons

A comparative experiment was performed to assess the palatability of blended beef burgers, composed of ratios of rehydrated mushroom product and beef, compared to unmodified beef burgers. Specifically, two experimental formulations were tested: one containing 34% rehydrated mushroom product (prepared by oil immersion frying at ambient temperature for 1 min at 175 oC) and 66% ground beef (80 CL), and the other containing an equal proportion of rehydrated mushroom product and beef (50:50). These blends were compared against a control group of 100% beef burgers to examine taste, texture, and overall acceptability.

To ensure comparable taste experiences, the fat level was held constant across all burger patties, adjusted through the addition of tallow to the blended mixes to achieve a 20% fat content. The cooking methodology was also controlled, with each patty cooked until an internal temperature of about 65° C. to 70° C. was achieved. Additionally, all patties were tasted in the same burger build, with some samples offered with cheese and some without. Specifically, four patties were cooked, and once the desired internal temperature was reached, the burgers were assembled. Two burgers featured a slice of cheese atop the patty, while the other two were cheese-free. Each participant was then served a quarter of each burger, clearly marked with a flag indicating the sample number (1, 2, 3, 4).

A total of 56 participants were canvassed, and the test panel consisted of culinary experts, beef manufacturers, and individuals with extensive experience in judging the quality and taste of meat. Following consumption, participants were asked to rate their experience based on two main questions:
1. How much did you enjoy this product, overall?
2. How did the flavour/taste live up to your expectations?

Ratings were given on a 5-point Likert scale, where 1 represented strong dislike and 5 indicated strong like. Results from the ratings are shown in Table 4.

TABLE 4
Rated experience

| | Rating^{a} | |
|---|---|---|
| Rating query | Blended | 100% Beef |
| How much did you enjoy this product, overall? | 4.4 | 4.2 |
| How did the flavour/taste live up to your | 4.2 | 4.2 |
| expectations? | | |

^{a}= Average rating calculated from participants based on a 5-point Likert scale where 1 represents a strong dislike and 5 indicates a strong like

Participants were also asked to rate mushroom taste based on the qualifiers of ‘no mushroom taste’, ‘significant mushroom taste’, ‘minor reduction in mushroom taste’, or ‘no reduction in mushroom taste.

Results from the test demonstrated that the mushroom blended mix received ratings on par with or slightly better than the 100% beef patties, suggesting a comparable or even superior taste experience. These findings are remarkable as they point towards the potential of blended patties as a healthier and more environmentally sustainable alternative to traditional 100% beef patties, without any sacrifice on taste or satisfaction. In terms of mushroom taste, the majority of the participants were unable to detect the presence of mushroom as summarised in Table 5.

TABLE 5
Mushroom taste comparison between beef and blended beef.

| Taste Qualifier | % of participants |
|---|---|
| No mushroom taste | 70% |
| Significant reduction in mushroom taste | 25% |
| Minor reduction in mushroom taste | 4% |
| No reduction in mushroom taste | 2% |

### Example 5: Microwave Treatment

This study proposes to further investigate the behaviour of naturally high-moisture mushroom particles subjected to microwave radiation within a vacuum chamber. It is predicted that physical and chemical processes under microwave vacuum conditions will give rise to novel structures, leading to animal meat-like textures and flavours through thermal-mechanical transformations of the mushroom material.

Mushroom particles of the desired shape and size (e.g. dices, mince, shreds, slices, strips or other particle with high surface area to volume ratio, preferably diced at 3-5 mm in size), having a starting water content of at least 50% (w/w) are placed into a vacuum microwave chamber, and microwave radiation is applied at controlled intervals. Preferably, the microwave power is from about 1 kW to about 5 kW, preferably from about 2 kW to 4 KW, the intensity of the microwave is set at about 20 W per g to about 100 W per g, preferably 40 W per g to about 70 W per g. Further, pressure is from about 1 kPa to about 80 kPa, further preferably from about 1 kPa to about 20 kPa, or about 20 kPa to about 50 kPa. The length of time for microwave treatment is from about 60 s to about 200 s, preferably about 100 s to about 150 s. Optionally, the mushroom particles may be coated lightly in oil prior to being microwaved. Alternatively (or additionally), oil is applied after microwaving prior to rehydration of the dehydrated mushroom ingredient.

It is expected that vacuum microwave treatment of mushroom particles will result in equivalent and surprising changes to TAC and WBC as noted in Table 3 for oil immersion frying and vacuum frying.

1. A method of producing a dehydrated mushroom ingredient with a modified rehydration capacity, comprising the steps of:
providing a raw mushroom material with at least 50% (w/w) water content;
oil immersion frying said raw mushroom material to produce a dehydrated mushroom ingredient with a water content of from about 5% (w/w) to about 30% (w/w); and
de-oiling the dehydrated mushroom ingredient to produce an ingredient with an oil content of at least 1% (w/w),
wherein the oil immersion frying is performed in an oil at a temperature from about 80° C. to about 200° C., at a pressure of 1.5 kPa to 103 kPa, and for a duration of about 10 seconds to about 900 seconds,
wherein said dehydrated mushroom ingredient excludes emulsions and/or binding agents, and wherein in use the dehydrated mushroom ingredient is rehydrated to produce texturised mushroom product with a water content of at least 40% (w/w).

2-3. (canceled)

4. The method of claim 1, wherein the dehydrated mushroom ingredient is packaged and stored prior to rehydration.

5. The method of claim 1, wherein the raw mushroom material has a water content of at least about 80% (w/w).

6. (canceled)

7. The method of claim 1, wherein oil immersion frying said raw mushroom material produces a dehydrated mushroom ingredient with a water content from about 1% (w/w) to about 25% (w/w).

8. The method of claim 1, wherein the oil immersion frying is performed in an oil at a temperature from about 110° C. to about 160° C., at a pressure of from about 1.5 kPa to about 10 kPa, and for a duration of about 10 seconds to about 900 seconds.

9. The method of claim 1, wherein the oil immersion frying is performed in an oil at a temperature from about 160° C. to about 190° C., at a pressure of at least about 100 kPa, and for a duration of about 10 seconds to 900 seconds.

10. The method of claim 1, wherein the raw mushroom material comprises fresh mushroom material.

11. The method of claim 1, wherein the raw mushroom material comprises dried and rehydrated mushroom material.

12. The method of claim 1, wherein the raw mushroom material comprises mushroom material that has been frozen, thawed and dewatered.

13. The method of claim 1, wherein the raw mushroom material consists essentially of mushroom material.

14. The method of claim 1, wherein the method further comprises the step of preparing the raw mushroom material.

15. The method of claim 1, wherein de-oiling produces a dehydrated mushroom ingredient with an oil content of less than 5% (w/w).

16-23. (canceled)

24. A method of producing a texturised mushroom product, comprising the steps of:
providing a raw mushroom material with at least 50% (w/w) water content;
oil immersion frying said raw mushroom material to produce a dehydrated mushroom ingredient with a water content from about 5% (w/w) to about 30% (w/w);
de-oiling the dehydrated mushroom ingredient to produce an ingredient with an oil content of at least 1% (w/w); and
rehydrating said dehydrated mushroom ingredient to produce a texturised mushroom product with a water content of at least 40% (w/w),
wherein the oil immersion frying is performed in an oil at a temperature from about 80° C. to about 200° C., at a pressure of 1.5 kPa to 103 kPa, and for a duration of about 10 seconds to about 900 seconds,
and wherein said texturised mushroom ingredient excludes emulsions and/or binding agents.

25. The method of claim 24, wherein the dehydrated mushroom ingredient is packaged and stored prior to rehydration.

26. The method of claim 24, wherein the raw mushroom material has a water content of at least about 80% (w/w).

27. The method of claim 24, wherein the dehydrated mushroom ingredient is rehydrated to produce a texturised mushroom product with a water content of at least about 70% (w/w).

28. The method of claim 24, wherein oil immersion frying said raw mushroom material produces a dehydrated mushroom ingredient with a water content from about 1% (w/w) to about 25% (w/w).

29. The method of claim 24, wherein the oil immersion frying is performed in an oil at a temperature from about 110° C. to about 160° C., at a pressure of from about 1.5 kPa to about 10 kPa, and for a duration of about 10 seconds to about 900 seconds.

30. The method of claim 24, wherein the oil immersion frying is performed in an oil at a temperature from about 160° C. to about 190° C., at a pressure of at least about 100 kPa, and for a duration of about 10 seconds to 900 seconds.

31. The method of claim 24, wherein the raw mushroom material comprises fresh mushroom material.

32. The method of claim 24, wherein the raw mushroom material comprises dried and rehydrated mushroom material.

33. The method of claim 24, wherein the raw mushroom material comprises mushroom material that has been frozen, thawed and dewatered.

34. The method of claim 24, wherein the raw mushroom material consists essentially of mushroom material.

35. The method of claim 24, wherein the method further comprises the step of preparing the raw mushroom material.

36. The method of claim 24, wherein de-oiling produces a dehydrated mushroom ingredient with an oil content of less than 5% (w/w).

37. The method of claim 24, wherein said dehydrated mushroom ingredient is rehydrated to produce a texturised mushroom product with a water content of not more than 95% (w/w).

38. The method of claim 24, wherein total absorption capacity (TAC) of the texturised mushroom product is from about 40% (w/w) to about 75% (w/w), preferably from about 45% (w/w) to about 65% (w/w).

39. The method of 38, wherein total absorption capacity (TAC) is measured according to the formula
$$TAC ( \% ) = ( ( final weight - initial weight ) / initial weight ) \times 100 ,$$
wherein the final weight is determined after rehydrating the dehydrated mushroom ingredient by blanching in water for about 5 mins at about 100° C. to produce the texturised mushroom product.

40. The method of claim 24, wherein water binding capacity of the texturised mushroom product is from about 40% (w/w) to about 75% (w/w), preferably from about 45% (w/w) to about 65% (w/w).

41. The method of 40, wherein water binding capacity (WBC) is measured according to the formula
$$WBC ( \% ) = ( ( initial weight - final weight ) / initial weight ) \times 100 ,$$
wherein the initial weight is determined after rehydrating the dehydrated mushroom ingredient by blanching in water for about 5 mins at about 100° C. to produce the texturised mushroom product, and wherein the final weight is achieved by subsequently dewatering the texturised mushroom product by centrifugation at 1200 rpm for about 30 to about 60 seconds.

42. A method of producing a texturised mushroom product, comprising the steps of:
providing a raw mushroom material with at least 50% (w/w) water content;
oil immersion frying said raw mushroom material to produce a dehydrated mushroom ingredient with a water content from about 5% (w/w) to about 30% (w/w);
de-oiling the dehydrated mushroom ingredient to produce an ingredient an oil content of at least 1% (w/w); and
rehydrating said dehydrated mushroom ingredient in an excess of liquid until such time as the mushroom ingredient and the liquid reach an absorption equilibrium to produce a texturised mushroom product,
wherein the oil immersion frying is performed in an oil at a temperature from about 80° C. to about 200° C., at a pressure of from about 1.5 kPa to about 103 kPa, and for a duration of about 10 seconds to about 900 seconds,
wherein said texturised mushroom ingredient excludes emulsions and/or binding agents, and wherein in use the dehydrated mushroom ingredient is rehydrated to produce texturised mushroom product with a water content of at least 40% (w/w).

43. The method of claim 42, wherein the dehydrated mushroom ingredient is packaged and stored prior to rehydration.

44. The method of claim 42, wherein the raw mushroom material has a water content of at least about 80% (w/w).

45. The method of claim 42, wherein the dehydrated mushroom ingredient is rehydrated to produce a texturised mushroom product with a water content of at least about 70% (w/w).

46. The method of claim 42, wherein oil immersion frying said raw mushroom material produces a dehydrated mushroom ingredient with a water content from about 1% (w/w) to about 25% (w/w).

47. The method of claim 42, wherein the oil immersion frying is performed in an oil at a temperature from about 110° C. to about 160° C., at a pressure of from about 1.5 kPa to about 10 kPa, and for a duration of about 10 seconds to about 900 seconds.

48. The method of claim 42, wherein the oil immersion frying is performed in an oil at a temperature from about 160° C. to about 190° C., at a pressure of at least about 100 kPa, and for a duration of about 10 seconds to 900 seconds.

49. The method of claim 42, wherein the raw mushroom material comprises fresh mushroom material.

50. The method of claim 42, wherein the raw mushroom material comprises dried and rehydrated mushroom material.

51. The method of claim 42, wherein the raw mushroom material comprises mushroom material that has been frozen, thawed and dewatered.

52. The method of claim 42, wherein the raw mushroom material consists essentially of mushroom material.

53. The method of claim 42, wherein the method further comprises the step of preparing the raw mushroom material.

54. The method of claim 42, wherein de-oiling produces a dehydrated mushroom ingredient with an oil content of less than 5% (w/w).

55. The method of claim 42, wherein said dehydrated mushroom ingredient is rehydrated to produce a texturised mushroom product with a water content of not more than 95% (w/w).

56. The method of claim 42, wherein total absorption capacity (TAC) of the texturised mushroom product is from about 40% (w/w) to about 75% (w/w), preferably from about 45% (w/w) to about 65% (w/w).

57. The method of 56, wherein total absorption capacity (TAC) is measured according to the formula
$$TAC ( \% ) = ( ( final weight - initial weight ) / initial weight ) \times 100 ,$$
wherein the final weight is determined after rehydrating the dehydrated mushroom ingredient by blanching in water for about 5 mins at about 100° C. to produce the texturised mushroom product.

58. The method of claim 42, wherein water binding capacity of the texturised mushroom product is from about 40% (w/w) to about 75% (w/w), preferably from about 45% (w/w) to about 65% (w/w).

59. The method of 58, wherein water binding capacity (WBC) is measured according to the formula
$$WBC ( \% ) = ( ( initial weight - final weight ) / initial weight ) \times 100 ,$$
wherein the initial weight is determined after rehydrating the dehydrated mushroom ingredient by blanching in water for about 5 mins at about 100° C. to produce the texturised mushroom product, and wherein the final weight is achieved by subsequently dewatering the texturised mushroom product by centrifugation at 1200 rpm for about 30 to about 60 seconds.
